(19) United States
(12) Patent Application Publication
(10) Pub. No.: US 2009/0094867 A1
(43) Pub. Date: Apr. 16, 2009

(54) Compact rescue signal device

(76) Inventor: Lloyd Bill Darnell, II, Gilbert, AZ (US)

Correspondence Address: LLOYD BILL DARNELL II, 437 S OCEAN DR, GILBERT, AZ, 85233, US

(21) Appl. No.: 12/009,906

(22) Filed: Apr. 1, 2008

Related U.S. Application Data
(60) Provisional application No. 60/887,266, filed on Jan. 30, 2007.

(51) Int. Cl. G09F 19/02

(52) U.S. Cl. 40/212

(57) ABSTRACT

The Compact Rescue Signal Device is designed to help lost or stranded hikers. This device is approximately the size of a small flashlight and comes in a variety of colors. When activating the lever a 30 Mylar balloon imprinted with the letter SOS is filled by a lighter than air gas. From this stage the balloon can be deployed and become more visible on the attached 75 foot tether to aid in the quicker recovery of lost or stranded hikers and helping to lower cost of state and federal rescue operations. Also included is a reflective disk on the outer cap of this device to assist when needed. The design of operation is easily operated by children and adults and light enough to carry in a pant pocket or small daypack.

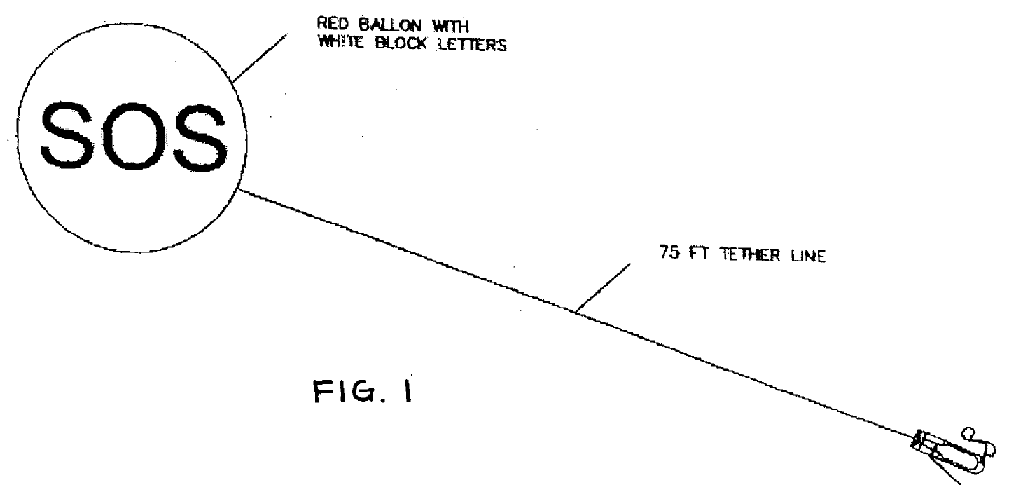

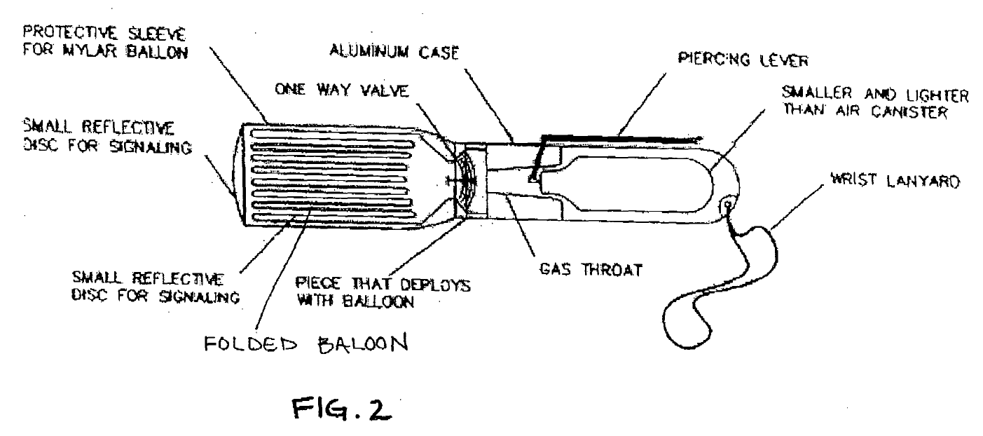

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Also, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As illustrated by the figures, there is an emergency signaling device. The illustrated emergency signaling device has an elongated housing, with a lighter-than-air filled canister inside. For example, one skilled in the art would appreciate that the elongated housing may be an aluminum case. In addition, one skilled in the art would appreciate that the lighter-than-air filled canister may contain helium, for example. The emergency signaling device also has a piercing lever configured to pierce the canister, and a gas throat going to a second portion of the canister. As illustrated, the gas throat provides a pathway for travel of gas from the canister.

Additionally, there is illustrated a spool circumferentially disposed about the gas throat. As shown, the spool is coupled to the emergency signaling device and a mylar balloon, respectively. In one embodiment of the invention, the spool is configured to tether the balloon to the emergency signaling device. For example, one skilled in the art would appreciate that the spool may be a rope constructed from a textile, such as hemp. Moreover, in a stored mode, the mylar balloon is disposed within the elongated housing, and in an inflated mode, the mylar balloon is disposed outside of the elongated housing.

Further, the illustrated emergency signaling device has a protective mylar sleeve disposed about the mylar balloon. In one embodiment of the invention, the protective mylar sleeve is configured to protect the mylar balloon. For example, the protective mylar sleeve may protect the mylar balloon from becoming ripped, punctured, or otherwise damaged by the components of the emergency signaling device while in a stored mode.

More, there is a small reflective disk shown at an end of the housing. In one embodiment of the invention, the reflective disk is configured to reflect light to signal rescuers. For example, one skilled in the art would appreciate that the reflective disk may be such as the highly reflective material of U.S. Pat. No. 4,872,414, issued to Asquith et al., which is incorporated by reference herein. Moreover, the figures illustrate a wrist lanyard coupled to the emergency signaling device for transportation of the device.

In operation of one embodiment of the invention, a person transports an emergency signaling device by holding a wrist lanyard of an elongated housing. Once the person becomes lost and/or trapped, the person uses a piercing lever of the device to pierce a lighter-than-air canister insider of the housing. The lighter-than-air canister then releases helium gas which travels along a gas throat and into a folded mylar balloon stored inside of the housing. The helium gas causes then causes the mylar balloon to expand and inflate. As the mylar balloon expands and inflates, it leaves the housing and travels upwardly, to a distance above the person, while a tether line tethers the mylar balloon to the housing. The mylar balloon then provides a signal to rescuers as to the location of the person.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate a balloon with block letters which spell SOS, it is envisioned that the lettering of the balloon may spell any signaling phrase appreciated in the art. For example, the balloon may include phrases, such as, but not limited to: “SOS,” “HELP,” and “CALL 911.” Similarly, one skilled in the art would appreciate that the balloon and/or lettering may be colored and/or reflective. For example, the balloon may reflect light such as the highly reflective material of U.S. Pat. No. 4,872,414, issued to Asquith et al., which is incorporated by reference herein. Likewise, the balloon may be red, with black lettering, for example.

Additionally, although the figures illustrate a wrist lanyard, it is envisioned that the emergency signaling device may have any mechanism for transportation of the device appreciated in the art. For example, the device may include transportation mechanisms, such as, but not limited to: rope, ties, hooks, clamps, snaps, and clips.

Further, it is envisioned that the housing may weigh more than the mylar balloon when inflated for weighing down the balloon. For example, one skilled in the art would appreciate that the housing may be weighted and/or include a weight.

It is expected that there could be numerous variations of the design of this invention. For example, the housing may have any size and/or shape appreciated in the art, such as, but not limited to: rectangular, trapezoidal, pyramidal, and tubular. Additionally, the balloon may have any size and/or shape appreciated in the art, such as, but not limited to: round, oval, and square.

Finally, it is envisioned that the components of the device may be constructed of a variety of materials. For example, the emergency signaling device may be constructed of materials, such as, but not limited to: metal, textiles, plastic, glass, and/or rubber. It is also envisioned that balloon may be constructed of any material appreciated in the art. For example, the balloon may be constructed of material, such as, but not limited to: mylar/polyester, rubber, and/or plastic.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An emergency signaling device, comprising:
an elongated housing with a lighter-than-air filled canister inside;
a piercing lever to pierce the canister;
a gas throat going to a second portion of the canister;
a spool circumferentially disposed about the gas throat;
a protective mylar sleeve disposed about a mylar balloon; and
a small reflective disk at an end of the housing.
